(19) United States
(12) Patent Application Publication
(10) Pub. No.: US 2026/0371263 A1
(43) Pub. Date: Nov. 19, 2026

(54) ADAPTIVE GAIN CONTROL BASED ON NOISE FLOOR DEVIATIONS FOR OUT-OF-BAND INTERFERENCE MITIGATION

(71) Applicant: Morse Micro Pty. Ltd., Surry Hills NSW (AU)

(72) Inventor: Mohammed Mohammed, Surry Hills NSW (AU)

(21) Appl. No.: 19/390,149

(22) Filed: Nov. 14, 2025

(30) Foreign Application Priority Data
May 13, 2025 (AU) 2025901830

(51) Int. Cl. H04W 52/36; H04L 5/00; H04W 52/24

(52) U.S. Cl. CPC H04W 52/367; H04L 5/0053; H04W 52/243

(57) ABSTRACT

Systems and techniques are provided for gain control and out-of-band (OOB) interference mitigation in a wireless device. A method includes obtaining noise measurements during an idle period for a wireless medium associated with the wireless device, wherein the noise measurements are indicative of a noise level within an operating bandwidth of the wireless device during the idle period. Based on the noise level, a noise floor metric indicative of elevation in a noise floor is determined for the operating bandwidth. A presence of OOB interference outside the operating bandwidth is determined by comparing the noise floor metric to at least one threshold to determine a comparison result, wherein the elevation in the noise floor is an indicator for the presence of the OOB interference. A front-end gain of a receiver of the wireless device is controlled according to at least one of the comparison result or the noise floor metric.

### CROSS-REFERENCE TO RELATED APPLICATIONS

This application claims the benefit of Australian Provisional Patent Application No. 2025901830, filed on May 13, 2025, which is hereby incorporated by reference, in its entirety and for all purposes.

### FIELD

The present disclosure generally relates to wireless communications. For example, aspects of the present disclosure are related to systems and techniques for automatic and/or adaptive gain control for mitigation of out-of-band interference on a wireless medium.

### BACKGROUND

Modern wireless communication systems may operate within dynamic environments characterized by varying signal strengths, fluctuating interference levels, and increasing spectral congestion. To contend with these dynamic operating environments, receiver architectures may be implemented subject to a design requirement that the receiver be able to maintain signal fidelity across a wide range of input signal conditions. One example technique that can be used by a wireless receiver is automatic gain control (AGC), which regulates receiver gain to ensure optimal signal fidelity, prevent saturation of receiver components, and maintain linearity across a range of input signal levels. For example, by using AGC to dynamically adjust the gain of one or more receive chain amplification stages in response to changing signal conditions, a receiver may better handle both relatively weak and relatively strong signal conditions.

Some AGC techniques can be implemented based on using the receiver to assess or measure the power levels of incoming signals, for example using received signal strength indicator (RSSI) information or in-band power detection information, among various others. The measured power level information or indicators can serve as triggers for one or more gain adjustment mechanisms associated with receiver front-end components. For example, when an RSSI or an in-band energy detector indicates that a relatively high input signal level is present, an AGC loop can be triggered to reduce the gain of a low-noise amplifier (LNA), a variable-gain amplifier (VGA), or other front-end amplification stage of the receiver. The automatic response to reduce the front-end gain can be used to prevent saturation that may otherwise compromise signal integrity and/or introduce distortion to the receiver. By reducing front-end gain in response to strong in-band signals, an AGC system can maintain the received signal within the linear operating region of subsequent receiver stages, such as mixers and analog-to-digital converters, among various others. However, AGC techniques that rely on RSSI or in-band energy detection may fail to capture or respond to out-of-band (OOB) interference, which is not represented in RSSI or in-band energy detection. For example, out-of-band interferers correspond to signals with a primary energy lying outside the operational frequency bandwidth of the receiver, and both RSSI and in-band energy detection focus primarily on signals with a primary energy that is within the operation frequency (e.g., operating frequency) bandwidth. As such, interference detection results based on RSSI or in-band energy detection may not reflect the presence or effects of strong interferers that are located outside of the monitored frequency band. The performance of the receiver can be degraded by the presence of these OOB interferers, which can couple into the receiver front-end through nonlinearities or insufficient out-of-band rejection. These interferers can lead to front-end compression or desensitization even when RSSI or in-band energy measurements indicate normal conditions. Unless these challenges are addressed, a wireless receiver system may remain vulnerable to performance degradation caused by out-of-band interference signals.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for automatic and/or adaptive gain control in a wireless device to mitigate out-of-band (OOB) interference, where the OOB interference can be detected based on using elevated idle period noise measurements as an indicator of OOB interference activity that is not visible to (e.g., not included or represented within, and/or not detected directly by, etc.) measurement approaches for in-band energy or noise measurement, such as RSSI or in-band energy detectors, among various others. For example, a method for gain control in a wireless device can include: obtaining one or more noise measurements during an idle period for a wireless medium associated with the wireless device, wherein the one or more noise measurements are indicative of a noise level within an operating bandwidth of the wireless device during the idle period; determining, based on the noise level, a noise floor metric indicative of elevation in a noise floor corresponding to the operating bandwidth; determining a presence of OOB interference located outside of the operating bandwidth based on comparing the noise floor metric to at least one threshold to determine a comparison result, wherein the elevation in the noise floor is used as an indicator for the presence of the OOB interference; and controlling a front-end gain of a receiver of the wireless device according to at least one of the comparison results of the noise floor metric.

In some aspects, controlling the front-end gain of the receiver comprises: reducing a gain of an amplifier in a receive chain; or bypassing one or more components in the receive chain, wherein the one or more components include the amplifier.

In some aspects, the amplifier comprises a low-noise amplifier (LNA) associated with a first gain for a normal mode configuration of the receiver; and reducing the gain comprises configuring the amplifier with a reduced gain less than the first gain, wherein the reduced gain corresponds to a reduced mode configuration of the receiver.

In some aspects, the wireless device includes an adaptive gain control component configured to generate one or more control signals to cause the wireless device to switch between the normal mode configuration and the reduced mode configuration.

In some aspects, the one or more noise measurements comprise a plurality of noise measurements, and determining the noise floor metric includes calculating an average noise level of the plurality of noise measurements.

In some aspects, the method further comprises comparing the average noise level with a configured threshold noise level to determine the comparison result, and wherein the indicator for the presence of the OOB interference comprises determining that the average noise level exceeds the configured threshold noise level.

In some aspects, the method further comprises identifying the idle period for the wireless medium as a quiet period associated with a medium access control (MAC) protocol implemented for the wireless medium and the receiver.

In some aspects, the idle period is within a distributed inter-frame space (DIFS), and is after a short inter-frame space (SIFS).

In some aspects, obtaining the one or more noise measurements during the idle period is performed beginning one or more slots after an end slot of the SIFS.

In some aspects, determining the noise floor metric comprises comparing the noise level against an expected threshold indicative of the presence of OOB interference, wherein the noise floor metric is an indicator for the presence of OOB interference based on a determination the noise level exceeds the expected threshold.

In some aspects, the method further comprises determining whether the OOB interference has cleared by comparing one or more additional noise measurements to an additional threshold, wherein the one or more additional noise measurements are obtained after an initial determination the OOB interference is present.

In some aspects, the method further comprises restoring the front-end gain of an amplifier of the receiver in response to a determination the OOB interference has cleared, wherein the determination the OOB interference has cleared is based on the one or more additional noise measurements indicating an updated noise floor metric below the additional threshold.

In some aspects, the method further comprises incrementing a hysteresis counter upon detection of an elevated noise floor based on the noise level; comparing the hysteresis counter to a high threshold; and controlling the front-end gain to initiate a gain reduction for in response to the hysteresis counter being greater than or equal to the high threshold, wherein the gain reduction causes the receiver to operate in a reduced gain mode.

In some aspects, incrementing the hysteresis counter comprises: computing an average noise level of multiple noise measurements; comparing the average noise level to a lower noise threshold; and incrementing the hysteresis counter in response to a determination the average noise level exceeds the lower noise threshold.

In some aspects, the method further comprises decrementing the hysteresis counter upon detection of a low noise floor while the receiver operates in the reduced gain mode; comparing the hysteresis counter to a low threshold; and restoring the front-end gain of the receiver in response to the hysteresis counter reaching the low threshold.

In some aspects, the detection of the low noise floor comprises determining an average noise level of the one or more noise measurements is less than an upper noise threshold.

In some aspects, restoring the front-end gain of the receiver comprises resetting the gain of an amplifier included in the receiver or re-activating an amplifier bypassed in a bypass mode of the receiver.

In some aspects, determining the noise floor metric includes calculating a statistical representation of one or more noise measurements or a measure of noise level over time.

In some aspects, calculating the statistical representation includes one or more of averaging a plurality of noise levels, performing statistical analysis of the plurality of noise levels, or performing historical data aggregation of noise levels across different operating conditions or time periods. In another illustrative example, provided is a wireless device operating in a wireless communication network, the wireless device comprising: a receiver configured for reception of one or more signals on a wireless medium, the receiver including a receive chain with at least one low-noise amplifier (LNA); a processor, communicatively coupled to the receiver; and one or more memory banks, communicatively coupled to the processor and storing processor-readable instructions that, when executed by the processor, cause the processor to: obtain one or more noise measurements during an idle period for the wireless medium, wherein the one or more noise measurements are indicative of a noise level within an operating bandwidth of the wireless device during the idle period; determine, based on the noise level, a noise floor metric indicative of elevation in a noise floor corresponding to the operating bandwidth; determine a presence of out-of-band (OOB) interference located outside of the operating bandwidth based on comparing the noise floor metric to at least one threshold to determine a comparison result, wherein the elevation in the noise floor is used as an indicator for the presence of the OOB interference; and control a front-end gain of the receiver by adjusting a gain of the LNA according to at least one of the comparison result or the noise floor metric.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following drawing figures:

FIG. 1 is a block diagram illustrating an exemplary wireless communication network;

FIG. 2A is a block diagram of a wireless communication device that can implement a station (STA) or access point (AP), in accordance with some embodiments;

FIG. 2B is a schematic block diagram of the receiver data flow architecture of the wireless communication device of FIG. 2A, in accordance with some embodiments;

FIG. 2C is a schematic block diagram of a transmitter data flow architecture that can be used to transmit Radio Frequency (RF) signals over a wireless medium, in accordance with some embodiments;

FIG. 3 is a diagram illustrating an example of out-of-band (OOB) interference across a frequency range, where the OOB interference overlaps at least partially with a band of interest at an input of a receiver to thereby cause OOB interference leakage in-band;

FIG. 4 is a timing diagram depicting an example of an idle period that can be used for noise measurement(s) between two packets, where the idle period includes a medium sensing time for performing the noise measurement(s), in accordance with some embodiments;

FIG. 5 is a flowchart diagram illustrating an example of a process for adaptive gain control using gain control hysteresis, in accordance with some embodiments;

FIG. 6 is a diagram illustrating an example architecture for an adaptive gain control system that can be used to implement aspects herein, in accordance with some embodiments;

FIG. 7 is a block diagram illustrating an example of a computing system for implementing certain aspects described herein, in accordance with some embodiments.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

### OVERVIEW

Aspects of the present invention can be used to provide adaptive gain control methods and techniques that can be used by a wireless device (e.g., such as a receiver) to detect and mitigate out-of-band (OOB) interference signals and conditions. For example, non-mitigated OOB interference can elevate the noise floor, which is a baseline level of background noise present in the receiver. For example, aspects of the present invention provide an adaptive gain control method where a wireless device is configured to measure a noise level during an idle period, perform a noise floor analysis to determine elevation in a noise floor, and subsequently control a gain of an amplifier in the wireless device according to the noise floor analysis result. The amplifier may be a low-noise amplifier (LNA) or other amplifier included after a mixer in a receiving chain of the wireless receiver. In some aspects, a wireless device is configured to determine OOB interference is present based on a result of the noise floor analysis indicating an elevated noise floor. For example, the elevated noise floor corresponding to determination of OOB interference can be based on a comparison between the measured noise level and an expected or configured threshold level. A measured noise level that exceeds the configured threshold may be identified as an indicator of OOB interference, while a measured noise level that is below the configured threshold is not used as an indicator of OOB interference.

The measured noise level that is compared against the threshold to determine the presence (or non-presence) of OOB interference may be a single noise level measurement, or may be an average noise level determined from multiple noise level measurements obtained by the wireless device. For example, the multiple noise level measurements can be obtained at different respective times, which may be within the same or different idle periods where the wireless device is configured to perform the measurement(s). When multiple noise level measurements are used to calculate an average noise level, the wireless device may be configured to compare the average noise level to a threshold value that is the same as, or different from, the threshold value that is used when the device obtains a single noise level measurement without averaging.

In some embodiments, the noise level measurement can be performed during a protocol-defined idle period, which may be an idle period that is specified according to a wireless communication standard used by the wireless receiver device. In one illustrative example, the receiver can be configured to identify (i.e., determine) the medium access control (MAC) protocol-defined idle period for sensing, and perform the noise level measurements during the identified MAC protocol-defined idle period. For instance, the idle period may be identified as being within a distributed inter-frame space (DIFS) and/or after a short inter-frame space (SIFS) in wireless local area network (WLAN) implementations. In some embodiments, the noise level measurements are conducted during an idle period identified after receiving or transmitting an acknowledgment (ACK). For example, the idle period is identified as being within a DIFS after receiving or transmitting an ACK. Based on performing the noise level measurements during the configured idle periods, the wireless receiver can more accurately assess background interference or noise without mixed contributions of desired, non-noise signal energy on the wireless medium. As noted above, in some embodiments, the noise floor analysis result is generated to include a statistical representation of the measured noise levels over time. For example, the statistical representation can be determined based on averaging multiple noise levels, statistical analysis of multiple noise levels, and/or historical data aggregation of noise levels across different operating conditions or time periods, etc.

In response to the noise floor analysis indicating OOB interference is present, the wireless receiver device can be configured to control the gain of one or more amplifiers to mitigate the interference effects of the OOB interferer. For example, controlling the gain can comprise reducing the gain to a pre-defined value (e.g., setting the adjusted gain to a pre-defined value independent of the current gain value), or reducing the gain by a pre-defined offset amount (e.g., setting the adjusted gain to the current gain value plus or minus the pre-defined offset amount). In some examples, controlling a gain of the amplifier can comprise bypassing the amplifier in response to the noise floor analysis indicating an OOB interference is present.

In some cases, the adaptive gain control method described herein can include evaluating whether or not a previously detected OOB interference has cleared, based on the receiver obtaining an additional (i.e., subsequent) noise floor measurement and comparing the additional noise floor measurement against the threshold to determine whether the OOB interference has cleared (e.g., based on the additional noise floor measurement being below the threshold) or is still present (e.g., based on the additional noise floor measurement exceeding the threshold). In some embodiments, the threshold value used for determining whether the OOB interference has cleared can be the same as the threshold value used for initially determining the presence of the OOB interference. In other examples, a lower threshold value may be used for determining whether the OOB interference has cleared, and a higher threshold value may be used for initially detecting the presence of the OOB interference. In other examples, a higher threshold value may be used for determining whether the OOB interference has cleared, and a lower threshold value may be used for initially detecting the presence of the OOB interference.

In some embodiments, separate detection and clearance threshold can be used to implement a hysteresis mechanism for the wireless receiver and the noise floor threshold-based gain adjustments. For instance, the hysteresis mechanism can be used to prevent or avoid frequent toggling of the wireless receiver between different gain states. For example, the receiver may increment a hysteresis counter each time the noise floor is determined to have exceeded a lower noise threshold, and may reduce the amplifier gain or bypass the amplifier when the hysteresis counter reaches a high counter threshold. The noise floor may be determined as a single noise level measurement or an average of multiple noise level measurements obtained by the receiver, as noted previously above. Similarly, the receiver may decrement the hysteresis counter when the noise floor is determined to be below an upper noise threshold while operating in a reduced-gain mode, and may restore the original gain or reactivate the bypassed amplifier when the hysteresis counter reaches a low counter threshold. In some aspects, restoring the gain of the amplifier can include resetting the gain of the amplifier and/or re-activating the amplifier according to various embodiments.

An example wireless device according to some embodiments includes an LNA that receives a radio frequency (RF) signal transmitted over a wireless network, a mixer coupled to an output of the LNA to down-convert the RF signal to a lower frequency, and an amplifier coupled to an output of the mixer to apply gain to the down-converted signal. The wireless device further includes a noise floor detector that measures noise levels during idle periods, and an adaptive gain controller. The adaptive gain controller may be coupled to the noise floor detector and to one (or both) of the LNA and the post-mixer amplifier. The adaptive gain controller is configured to analyze or detect elevation in the noise floor based on the measured noise levels. The adaptive gain controller subsequently controls the gain of the LNA, the post-mixer amplifier, or both, based on the noise floor analysis results. In some embodiments, the wireless device includes an analog-to-digital converter (ADC) coupled to an output of the post-mixer amplifier, digital filters coupled to an output of the ADC, and a baseband energy meter coupled to an output of the digital filters. The baseband energy meter generates a digital power estimate or noise metric that the noise floor detector uses to assess the noise floor. By performing noise floor assessment in the digital domain after filtering, the wireless device can isolate noise energy within the desired signal band and can reduce the influence of out-of-band components that would be filtered out during normal signal processing.

### EXAMPLE EMBODIMENTS

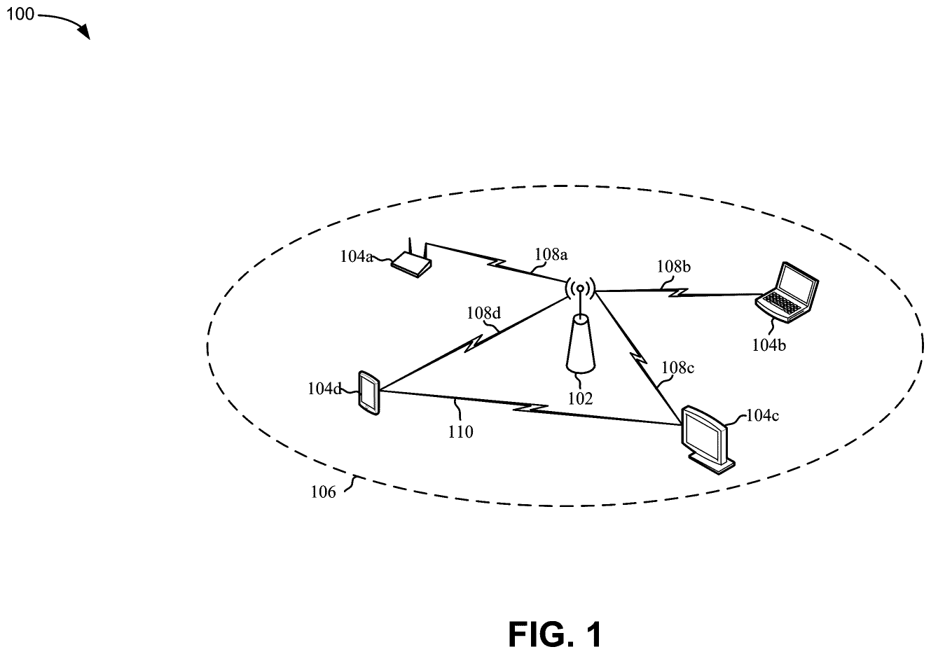

FIG. 1 is a block diagram illustrating an exemplary wireless communication network 100. In some aspects, the wireless communication network 100 can be an example of a Wireless Local Area Network (WLAN). As used herein, a WLAN may be a Wi-Fi network. In some examples, the WLAN 100 can be a network implementing at least one of the IEEE 802.11 family of wireless communication protocol standards (e.g., such as that defined by the IEEE 802.11-2020 specification or amendments thereof including, but not limited to, 802.11ah, 802.11ay, 802.11ax, 802.11az, 802.11ba and 802.11be). The WLAN 100 may include at least one AP 102 and multiple associated STAs 104. For example, the STAs 104 can include a first STA 104a, a second STA 104b, a third STA 104c, a fourth STA 104d, etc. While only one AP 102 is shown, the WLAN network 100 also can include multiple APs 102.

Each of the STAs 104a-104d may be referred to as a Mobile Station (MS), a mobile device, a mobile handset, a wireless handset, an Access Terminal (AT), a User Equipment (UE), a Subscriber Station (SS), and/or a subscriber unit, among other examples. The STAs 104 may represent various devices such as mobile phones, handheld devices, netbooks, computers, tablet computers, laptops, display devices (e.g., TVs, computer monitors, navigation systems, etc.), music or other audio or stereo devices, remote control devices (“remotes”), printers, kitchen or other household appliances, key fobs (e.g., for Passive Keyless Entry and Start (PKES) systems), etc.

A single AP 102 and an associated set of STAs 104a-104d may be referred to as a Basic Service Set (BSS), which is managed by the respective AP 102. FIG. 1 additionally shows an example coverage area 106 of the AP 102, which may represent a Basic Service Area (BSA) of the WLAN 100. The BSS may be identified to users by a Service Set Identifier (SSID), as well as to other devices by a Basic Service Set Identifier (BSSID), which may be a Medium Access Control (MAC) address of the AP 102.

The AP 102 periodically broadcasts beacon frames (“beacons”) including the BSSID to enable any STAs (e.g., such as one or more, or all, of the STAs 104a-104d) within wireless range of the AP 102 to associate or re-associate with the AP 102 to establish a respective communication link 108a-108d (e.g., hereinafter also referred to as a “Wi-Fi link”). For example, the first STA 104a can establish a respective communication link 108a with the AP 102, the second STA 104b can establish a respective communication link 108b with the AP 102, the third STA 104c can establish a respective communication link 108c with the AP 102, the fourth STA 104d can establish a respective communication link 108d with the AP 102, etc. The STAs 104a-104d may additionally use the beacon frames broadcast by AP 102 to maintain the respective communication link 108a-108d with the AP 102. For example, the beacons can include an identification of a primary channel used by the respective AP 102 as well as a timing synchronization function for establishing or maintaining timing synchronization with the AP 102. The AP 102 may provide access to external networks to various STAs in the WLAN via respective communication links 108.

To establish the communication links 108a-108d with an AP 102, each of the respective STAs 104a-104d can perform passive or active scanning operations (“scans”) on frequency channels in one or more frequency bands. For example, to perform passive scanning, each of the STAs 104a-104d listens for beacons that are transmitted by the AP 102 at a periodic time interval referred to as the Target Beacon Transmission Time (TBTT). The TBTT can be measured in Time Units (TUs). In some examples, one TU may be equal to 1024 microseconds (μs). In some examples, the TBTT can have a default value of 102.4 milliseconds (ms). To perform active scanning, each of the STAs 104a-104d can generate and sequentially transmit probe requests on each channel to be scanned and listens for probe responses from the AP 102. Each of the STAs 104a-104d may be configured to identify or select an AP 102 with which to associate (e.g., based on the scanning information obtained through the passive or active scans), and to perform authentication and association operations to establish a respective communication link 108a-108d with the selected AP 102. The AP 102 assigns an Association Identifier (AID) to each of the STAs 104a-104d at the culmination of the association operations, which the AP 102 uses to track the STAs 104a-104d.

In some cases, one or more of the STAs 104a-104d may have the opportunity to select one of many BSSs within range of the STA or to select among multiple APs 102 that together form an Extended Service Set (ESS) including multiple connected BSSs. An extended network station associated with the WLAN 100 may be connected to a wired or wireless distribution system that may allow multiple APs 102 to be connected in an ESS. In some examples, one or more of the STAs 104a-104d can be covered by more than one AP 102 and can associate with different APs 102 at different times for transmissions. After association with an AP 102, one or more of the STAs 104a-104d also may be configured to periodically scan its surroundings to find a more suitable AP with which to associate. For example, a given one of the STAs 104a-104d that is moving away from its associated AP 102 may perform a “roaming” scan to find another AP having more desirable network characteristics (e.g., such as a greater Received Signal Strength Indicator (RSSI), a reduced traffic load, etc.).

In some cases, the STAs 104a-104d may form networks without APs 102 or other equipment other than the STAs 104a-104d themselves. One example of such a network is an ad hoc network. Some examples of an ad hoc network are mesh networks and peer-to-peer (P2P) networks. In some cases, ad hoc networks may be implemented within a larger wireless network In such implementations, while the STAs 104a-104d may be capable of communicating with each other through the AP 102 using the respective communication links 108a-108d, the STAs 104a-104d, the STAs may also communicate directly with each other using direct wireless links 110. In some examples, two STAs may communicate via a direct communication link 110 regardless of whether both STAs 104 are associated with and served by the same AP 102. In such an ad hoc system, one or more of the STAs 104a-104d may assume the role filled by the AP 102 in a BSS. Such a STA may be referred to as a Group Owner (GO) and may coordinate transmissions within the ad hoc network. Examples of direct wireless links 110 can include one or more of Wi-Fi Direct connections, connections established by using a Wi-Fi Tunneled Direct Link Setup (TDLS) link, and other P2P group connections, etc.

The APs 102 and STAs 104a-104d may function and communicate using the respective communication links 108a-108d according to at least one of the IEEE 802.11 wireless communication protocol standards. These standards define the WLAN radio and baseband protocols for the physical (PHY) and Medium Access Control (MAC) layers. For example, the APs 102 and STAs 104a-104d transmit and receive wireless communications to and from one another in the form of PHY Protocol Data Units (PPDUs) or Physical Layer Convergence Protocol (PLCP) PDUs. The APs 102 and STAs 104a-104d in the WLAN 100 may transmit PPDUs over a license or unlicensed spectrum, which may be a portion of spectrum that includes frequency bands traditionally used by Wi-Fi technology, such as the 2.4 GHz band, the 5 GHz band, the 60 GHz band, the 3.6 GHz band, and the sub-1 GHz band. Some implementations of the APs 102 and STAs 104a-104d described herein also may communicate in other frequency bands, such as the 6 GHz band, which may support both licensed and unlicensed communications. The APs 102 and STAs 104a-104d also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11 standards and specifications may be transmitted over frequency bands that are divided into multiple 20 MHz channels. In such examples, the PPDUs are transmitted over a physical channel having a minimum bandwidth of 20 MHz, although other channel bandwidths are also possible. In some cases, a larger bandwidth channel can be formed using channel bonding, which bonds together multiple channels each of the minimum bandwidth.

Each PPDU is a composite structure that includes a PHY preamble and a payload in the form of a PHY Service Data Unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

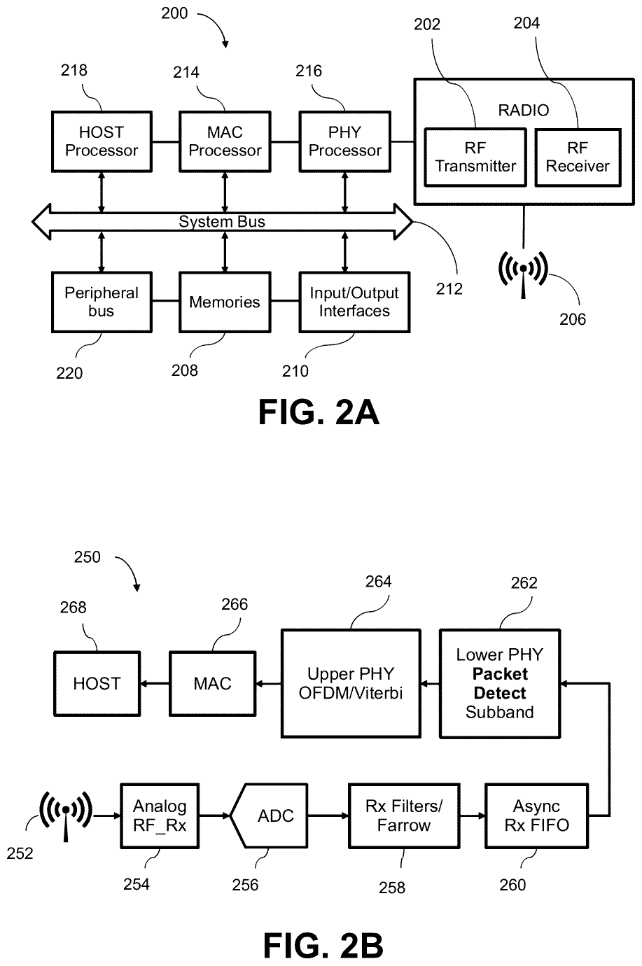

FIG. 2A is a high-level block diagram of an exemplary wireless communication device 200 that can be used to implement a STA or an AP, in some examples. The wireless communication device 200 can include a MAC layer and a PHY layer in accordance with one or more of the IEEE 802.11 standards.

The wireless communication device 200 includes a Radio Frequency (RF) transmitter module 202, an RF receiver module 204, an antenna unit 206, one or more memory banks 208, input and output interfaces 210, and communication bus 212. The RF transmitter module 202 and the RF receiver module 204 include a modem (modulator-demodulator device), which transmits data by modulating one or more carrier wave signals to encode digital information, as well as receives data by demodulating the signal to recreate the original digital information. As illustrated, the wireless communication device 200 further includes a MAC processor 214, a PHY processor 216 and a HOST processor 218. These processors can be any type of Integrated Circuit (IC) including a general processing unit, an Application Specific Integrated Circuit (ASIC) or Reduced Instruction Set Computer-Five (RISC-V) based ICs, amongst others.

The memory 208 can be used to store software and/or computer-readable instructions, including software or instructions that can be used to implement at least some functions of the MAC layer. For example, each processor included in the wireless communication device 200 (e.g., MAC processor 214, PHY processor 216, HOST processor 218, etc.) executes respective software to implement the functions of the respective communication/application layer.

The PHY processor 216 includes a transmitting signal processing unit and a receiving signal processing unit (not shown) and can be used to manage the interface with the Wireless Medium (WM). The PHY processor 216 operates on PPDUs by exchanging digital samples with the radio module which includes the RF transmitter 202, the RF receiver 204, analog-to-digital converters, and digital filters.

The MAC processor 214 executes MAC level instructions and manages the interface between the application software and the WM, through the PHY processor 216. The MAC processor 214 is responsible for coordinating access to the WM so that the AP and STAs in range can communicate effectively. The MAC processor 214 adds header and tail bytes to units of data provided by the higher levels and sends them to the PHY layer for transmission. The reverse happens when receiving data from the PHY layer. If a frame is received in error, the MAC processor 214 manages the retransmission of the frame.

The HOST processor 218 interfaces with the MAC layer and is responsible for running higher level functionalities of the wireless communication device.

The PHY processor 216, the MAC processor 214, the HOST processor 218, the peripheral bus 220, the memories 208, and the input/output interfaces 210 communicate with each other via the peripheral bus 212. The peripheral bus 220 connects to a number of peripherals that support core functions of the wireless communication device 200, including timers, interrupts, radio/filters/system registers, counters, UART, GPIO interfaces, among others. The memory 208 may further store an operating system and applications. In some examples, the memory may store recorded information about captured frames and packets. The input/output interface unit 210 allows for exchange of information with a user of the wireless communication device. The antenna unit 206 can include a single antenna and/or can include multiple antennas. For example, multiple antennas can be used to implement Multiple Input Multiple Output (MIMO) techniques, among others.

FIG. 2B illustrates a schematic block diagram of a receiver data flow architecture 250 that can be used to receive Wi-Fi packets over the network. In one illustrative example, the receiver data flow architecture 250 illustrated in FIG. 2B can correspond to or otherwise be associated with the wireless communication device 200 illustrated in FIG. 2A. Radio signals are received over the WM and translated into electrical signals by the receiving antenna 252 (e.g., which can be the same as or similar to antenna 206). The received signal is conditioned using a series of analog filters 254 (e.g., depicted as analog RF receive (Rx) filters) before being converted into a digital signal equivalent using an Analog-to-Digital Converter (ADC) 256. The sampled signal output of ADC 256 is conditioned again using a filter bank 258, which can include one or more digital RF filters and/or a farrow, before the samples are collected in an asynchronous receiving First-In-First-Out (FIFO) data structure 260.

Samples in FIFO structure 260 can be accessed by a plurality of modules. For example, samples can be accessed by a packet detect module and a sub-band module, both of which may be included in the lower-level PHY portion 262 depicted in FIG. 2B. In some embodiments, the lower-level PHY portion 262 is itself included in the PHY processor 216 illustrated in FIG. 2A.

The packet detect module included in the lower-level PHY portion 262 includes hardware and/or implement algorithms that are used to analyze the initial sections of the PPDU in the time domain. Based on the analysis, the packet detect module is used to recognize a received frame and synchronize frequency and timing of the wireless communication device with the packet being received. The sub-band module included in the lower-level PHY portion 262 includes hardware and/or implement algorithms that can be used to detect which subchannel in the allocated frequency band is being used for the packet being received.

Once a packet is detected and the relevant subchannel is established, samples can be forwarded to an upper-level PHY portion 264. The upper-level PHY portion 264 can be included in the PHY processor 216 illustrated in FIG. 2A. In some aspects, upper-level PHY portion 264 is used to process and decode Orthogonal Division Multiplexing (OFDM) symbols (e.g., with the support of a coprocessor module) to reconstruct the full PPDU. The reconstructed PPDU is output by the upper-level PHY portion 264 and subsequently processed by the MAC layer processor 266. The MAC layer processor 266 is used to extract the data payload from the PPDU and provide the relevant information to the HOST layer 268 for consumption.

In some examples, the MAC layer processor 266 illustrated in FIG. 2B can be the same as or similar to the MAC processor 214 illustrated in FIG. 2A. In some cases, the HOST layer 268 illustrated in FIG. 2B can include or otherwise can be the same as or similar to the HOST processor 218 illustrated in FIG. 2A.

FIG. 2C is a schematic block diagram of a transmitter data flow architecture 280 that can be used to transmit RF signals over a wireless medium, in accordance with some examples. More particularly, FIG. 2C illustrates a simplified schematic block diagram of a transmitter data flow architecture 280 used for transmitting radio signals over a WM. Data can be generated from a HOST or APP module 282 and packaged in a MAC level Protocol Data Unit (MPDU) to be routed over the wireless network by the MAC management module 284. The PHY module 286 interfaces with the WM and compiles a PPDU by adding a PHY preamble and the tail to the MPDU. Usually a Modulation Coding Scheme (MCS) for transmission of the packet over the medium is established using a rate control algorithm by the MAC module 284 or the PHY module 286. The modulation scheme selected can define the modulation technique to be used to transmit the data on the WM and the coding rate. Based on the modulation scheme selected, for example Quadrature Amplitude Modulation (QAM) 64, the PPDU is modulated to be transmitted on the WM. The encoder module 288 generates signals corresponding to points of QAM constellation symbols (groups of bits of the PPDU) which can be encoded using polar (r-θ) or cartesian (Q-I) coordinates. The modulation is done by linking the encoder module 288 to a Digital Phase Lock Loop (DPLL) 290. The modulated signals may be filtered by analog filters 292 and transmitted using a transmitting antenna 294.

In some embodiments, the disclosed systems and methods for adaptive gain control can be used for detection and mitigation of out-of-band (OOB) interference for one or more wireless receiver devices which, in some examples, can be Wi-Fi HaLow devices. Such devices may operate in accordance with the IEEE 802.11ah standard over Sub-1 GHz (S1G) license-exempt bands, thereby enabling extended-range and lower-power Wi-Fi connectivity for various applications. Wi-Fi HaLow devices operate in the license-free ISM (Industrial, Scientific, and Medical) frequency bands under one gigahertz (GHz). A Wi-Fi HaLow AP can provide connectivity to thousands of Stations STAs within a network coverage of approximately a one-kilometer radius. Wi-Fi HaLow supports various bandwidths, including 1 MHz, 2 MHz, 4 MHz, 8 MHz, and 16 MHz, which are approximately one order of magnitude narrower (e.g., 10 times narrower) than the bandwidths utilized by the IEEE 802.11ac (Wi-Fi 5) standard. Interference can cause significant impairments to packet reception in wireless communication systems such as Wi-Fi HaLow. For example, Wi-Fi HaLow devices may be more susceptible to negative effects of relatively high-power interference due to the sub-1 GHz (S1G) operational frequency bands. In many cases, the S1G bands are slightly regulated or license-free bands, and are increasingly congested with higher-powered services and devices, many of which legally transmit at power levels that can significantly exceed those of lower-powered HaLow devices. The low-power design and extended range used for many HaLow devices and receivers can correspond to relatively high receiver sensitivities designed to detect weak signals from distant HaLow or IoT devices. These high receiver sensitivities, while beneficial for long-range communication, make HaLow devices more vulnerable to packet reception degradation in the presence of interference signals, including OOB interference signals as contemplated herein.

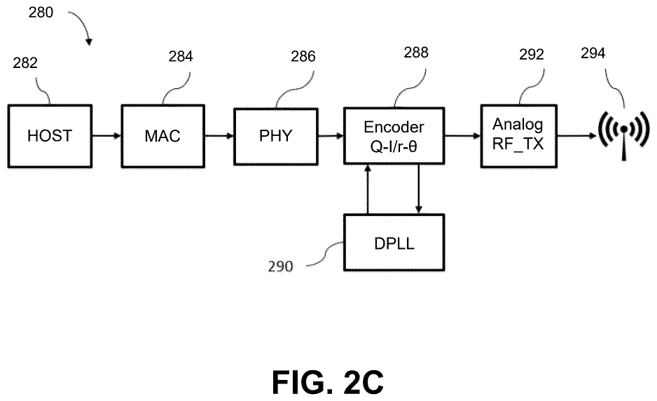

For example, FIG. 3 is a diagram illustrating an example of out-of-band (OOB) interference across a frequency range 300, in accordance with some examples. In the diagram of FIG. 3, the horizontal axis (e.g., x-axis) represents frequency, and the vertical axis (e.g., y-axis) represents amplitude (e.g., signal strength, magnitude, level, etc.). An OOB interference signal 310 is shown, with its peak centered around a frequency outside the band of interest. The signal power of the OOB interference 310 gradually decays on both sides of this center frequency until it diminishes below detectable levels at lower and upper frequency limits. Other profiles and shapes of OOB interference signals along a frequency axis or frequency range are also possible, without departing from the scope of the present disclosure and it is noted that the examples of OOB interference signal 310 is shown here for purposes of illustration and example.

The OOB interference signal 310 has a maximum amplitude or power level at a first frequency within the frequency range 300, as noted above. The maximum OOB interference signal 310 may be located at this first frequency value, which is shown in the example of FIG. 3 as being lower than a band of interest 330. The band of interest 330 can be an operational frequency band (also referred to herein as an operation bandwidth and/or an operational bandwidth) used by or otherwise associated with a wireless device, such as a wireless receiver, etc. Signals transmitted to or from the wireless device that using the band of interest 330 (i.e., transmitted and/or received signals within the band of interest 330) correspond to in-band energy, while the portion of OOB interference signal 310 that are not included within the band of interest 330 correspond to out-of-band energy. The out-of-band energy ideally should be rejected or ignored by the wireless receiver device when performing transmission or reception on the band of interest 330.

However, a challenge arises when a high power OOB interferer is present near the band of interest 330. For example, the OOB interference signal 310 shown in FIG. 3 is near the band of interest 330, shown in FIG. 3. The band of interest 330 is associated with a second frequency value/range that is near the OOB interference signal 310 center frequency of maximal OOB interference. However, because the OOB interferer is located (within the frequency range) relatively close or nearby to the band-of-interest, the OOB interference can lead to undesired compression effects on the receiver.

As noted previously, existing energy detection and/or interference detection techniques are largely based on techniques using standard received signal strength (RSSI) and/or in-band energy detectors. RSSI-based techniques and in-band energy detectors cannot detect or prevent impairment caused by OOB interference, such as the OOB interference signal 310, which lies outside of the operating frequency bandwidth of the band of interest 330. As the OOB interference signal 310 is out-of-band with respect to the operating frequency bandwidth 330, application or use of the standard RSSI and/or in-band detector measurements may not provide detection for the OOB interference signal 310. More particularly, although some in-band effects or apparent noise elevation may result from the OOB interference, these effects are not detected by a wireless device using the standard RSSI and/or in-band energy detector techniques. The presence of leakage outside a transmitter's frequency band may result from non-ideal filtering, which is unavoidable in practice. The relatively high power level of the OOB interference (e.g., such as the OOB interference 310, etc.) can cause compression and non-linearities at the receiver, which again, can go undetected by a receiver using the standard RSSI or in-band energy detector techniques. Such OOB-induced front-end degradation can further introduce intermodulation distortion to the receiving chain operations performed by the receiver device within the band of interest 330, and/or may trigger desensitization effects that degrade the overall system performance of the wireless receiver device. The vulnerability and lack of mitigation associated with conventional techniques and OOB interference leakage (e.g., such as the OOB interference leakage 335 in the example of FIG. 3, etc.) corresponds to a need for systems and methods that can be used to provide enhanced and improved automatic gain control (AGC) mechanism that can detect and compensate (e.g., mitigate, reduce, etc.) for interference sources beyond the configured operating frequency bandwidth of a receiver.

In some embodiments, the disclosed OOB interference detection and mitigation techniques can be implemented for a wireless device (e.g., such as a receiver) based on a two phase design. A first phase corresponds to OOB interference detection by the wireless device, and may also be referred to as an OOB interference detection phase. A second phase corresponds to mitigation of the detected OOB interference from the first phase, and may also be referred to as a mitigation phase. The detection phase and the mitigation phase are described in turn below.

In an illustrative example, the receiver device can be configured during the detection phase to monitor for abnormal increases in the noise level on a wireless medium and/or a monitored frequency range on the wireless medium. An abnormal increase in the noise level may be an increase in the noise level that is not just a transient change or transient effect. For example, abnormal increases in the noise level may be determined based on detecting an increase that exceeds a threshold increase associated with transient changes, etc. As noted above, the receiver can perform the detection phase by performing the monitoring to determine one or more measurements of a noise level, and comparing the measured nose level against an expected threshold, which represents an anticipated baseline level for the noise when no OOB interference is present. In some embodiments, one or more (or all) of the noise level measurements that are determined by the receiver may be based on measurements that are taken while the receiver is idle. For example, the noise level measurements can be determined by the receiver during idle periods where the receiver does not perform other transmission(s) or reception(s) on the same frequency range and/or adjacent frequency ranges to the monitored frequency range of interest (e.g., the operating bandwidth, also referred to as the in-band frequency range, etc.). By performing the noise level measurements while the receiver is idle, the underlying observations for the noise measurements are not corrupted or reduced in accuracy by contributions from active signal reception at the same time and/or on the same frequency resources, etc. In some embodiments, the noise level measurements can be obtained and/or determined based on noise sampling performed by the receiver. For example, noise sampling can be performed during idle periods of the receiver, as noted above. More particularly, in at least some examples, the receiver may be configured to perform noise sampling to obtain one or more noise level measurements (e.g., also referred to as noise samples or noise level samples, etc.) following a valid packet reception by the receiver. For example, noise sampling after a valid packet reception by the receiver may be performed independently from whether the valid packet reception is followed by a transmission or not.

In some embodiments, the receiver can be configured to perform noise sampling after a valid acknowledgement (ACK) or block ACK is received or transmitted. For example, the valid ACK or block ACK acknowledges a successful packet reception (e.g., by a receiving device) and/or a successful packet transmission (e.g., by a transmitting device). In this example, the valid ACK can correspond to a single packet, and may indicate or otherwise confirm that the previous packet was received or transmitted correctly. A block ACK can correspond to multiple packets, with a valid block ACK indicating or otherwise confirming that a block of multiple previous packets were received or transmitted correctly. Accordingly, in some embodiments the receiver can be configured to initiate sampling (e.g., trigger sampling, etc.) only after a valid ACK or block ACK is received, indicating that the previous packet was received or transmitted correctly, and thereby avoiding false measurements (e.g., noise sampling) due to failed receptions (e.g., for which the valid ACK or block ACK would not be received).

To improve reliability and reduce false triggers, the receiver can perform a noise floor analysis to determine noise floor information. The noise floor information may be a statistical representation of the measured noise levels over time. The noise floor can be determined through averaging multiple measured noise levels to smooth out anomalies that may be present in individual noise levels and/or within a small number of noise level measurements, etc. By averaging the multiple measured noise levels, the receiver can determine an average noise floor over the period of time that is reflected within the averaging of the multiple measured noise levels. In some cases, the noise floor analysis can have a noise floor analysis result that reveals the presence or existence of a consistent background noise. In some cases, the noise floor analysis can include performing a statistical analysis, such as computing the mean, median, or a selected percentile range of the measured noise distribution measured or otherwise determined by the receiver.

In some embodiments, the noise floor can be determined based on historical data aggregation performed by the receiver for some, or all, of the range of measurements subject to the noise floor analysis. For example, the receiver can perform historical data aggregation to obtain information corresponding to previously observed noise characteristics across different operation conditions, different time periods, etc., that may be combined to establish a reliable baseline for the noise analysis performed by the receiver for the current time. The historical aggregation-based approach to the noise floor baseline establishment can result in a noise floor baseline that reflects a more robust and representative indicator of the channel behavior and noise properties, while reducing or eliminating the influence of more transient spikes or other measurement artifacts that may more strongly affect individual or discrete noise floor measurements, etc.

The noise floor is then compared to one or more thresholds to determine if OOB interference is present. If the receiver has previously determined that OOB interference is present, the noise floor measurement for the current time may represent a follow-up or additional measurement that is used to determine whether the earlier detected OOB interference has cleared, or is still present. The determination of whether or not an earlier detected OOB interference has cleared can also be performed based on the receiver comparing the noise floor measurement to a threshold, and the threshold used for the follow-up determination of whether an earlier detected OOB interference has cleared may be the same as or different from the threshold used for the initial determination of whether OOB interference is present. The thresholds used for the noise floor analysis, and the interference detection and/or mitigation performed by the receiver, may be implemented as fixed or pre-defined values, may be implemented using one or more programmable, configurable, and/or adjustable values, and/or may be implemented using various combinations thereof. Based on a determination that the measured and/or calculated noise floor determined by the receiver exceeds a threshold, the receiver can exit the OOB interference detection phase and may trigger (e.g., enter) the mitigation phase to initiate a response for mitigating the detected OOB interference.

For example, in the second, interference mitigation phase of the adaptive gain control mechanism, the front-end gain of the receiver (e.g., a gain of one or more amplifiers or other front-end receive components of the receiver device, etc.) can be automatically and/or adaptively reduced upon triggering a response from the interference detection phase. For example, the gain of a low-noise amplifier (LNA) or other front-end component of the receiver may be decreased by a pre-defined (e.g., fixed or static, etc.) value, or may be decreased by a dynamic adjustable value. In some embodiments, the LNA gain (and/or other front-end receiver component gain) may be decreased to a pre-defined value that is lower than the current gain. In some embodiments, the LNA (and/or other front-end receiver component) may be entirely bypassed within the receiver's RF front-end receive processing chain in response to detection of an OOB interference and/or in response to detection of an OOB interference with characteristics configured to trigger or otherwise cause the receiver to perform the bypass rather than the gain reduction for the LNA or other front-end receiver component.

In some aspects, during the mitigation phase the receiver is configured to maintain the selected mitigation (e.g., the reduced gain or the bypass state implemented for the LNA or other front-end receiver component) as long as the noise level remains elevated, either above the initial threshold that triggered the OOB interference detection phase, or above a second threshold that is configured for monitoring for when the OOB interference is cleared. Configuring the receiver to maintain the selected mitigation from the mitigation phase until determining that a second condition (e.g., the condition for clearing the OOB interference) is met can be used to ensure that the resulting noise figure (NF) for the receiver does not raise the overall system noise floor beyond the currently observed level.

The decision logic of the disclosed OOB interference detection and mitigation techniques may be implemented using a comparison-based thresholding approach, where, in at least some embodiments, an average noise level is determined from accumulated energy readings of multiple noise measurements, and is subsequently evaluated against defined thresholds.

In some cases, the receiver can be configured with multiple modes of operation that may be associated with, or associated to, the OOB interference detection and mitigation techniques. For example, when the receiver is in a normal mode, OOB interference is not currently detected and mitigations are not currently applied to bypass or reduce the gain. While the receiver is in the normal mode, the receiver may perform the first OOB interference detection phase operations described above, and may identify an average noise level that rises above a pre-defined lower threshold value. Based on the determination that the average noise level exceeds the pre-defined lower threshold, the receiver can automatically switch from the normal mode to a reduced gain mode (e.g., corresponding to the gain reduction for one or more LNAs or front-end components of the receiver) and/or can automatically switch from the normal mode to a bypass mode (e.g., corresponding to bypassing the one or more LNAs or front-end components of the receiver entirely in the receive processing chain of the receiver).

In some aspects, the receiver may automatically switch from the reduced gain mode to the bypass mode, based on determining a further increase to the average noise level that exceeds an additional threshold configured corresponding to a bypass mode trigger, and/or that causes saturation of the LNA or other receiver components that are bypassed in the bypass mode. Conversely, while in the reduced mode and/or the bypass mode, the receiver may continue to monitor the average noise level during the configured idle periods for monitoring. Based on detecting or determining that the average noise level falls below a pre-defined upper threshold indicating that the previously detected OOB interference has likely cleared, the receiver switches back to the normal mode from the reduced mode and/or the bypass mode.

In some embodiments, the adaptive gain control mechanism can include a recovery phase where the receiver is configured to restore the gain to the one or more LNAs or other front-end components that were configured with an adjusted (reduced) gain during a reduced mode of the receiver, or that were bypassed entirely during a bypass mode of the receiver. The recovery phase can restore the one or more LNAs or other front-end components back to a respective gain configured for the normal mode operations of the receiver. The recovery phase can be configured to maximize sensitivity and maintain optimal reception performance for the receiver device once the OOB interference has likely cleared (e.g., based on the recovery phase being triggered when the receiver detects the average noise level falling below the pre-defined upper threshold, etc.). During the recovery phase, the front-end gain is restored and/or the LNA is re-enabled based on the noise measurements triggering the recovery phase (and further based on whether the receiver transitions to the recovery phase and normal mode starting from either the bypass mode or the reduced mode). For instance, if the gain was reduced during the interference mitigation phase and the receiver subsequently determines the measured noise floor falls below a defined upper noise threshold, the receiver can be configured to interpret this as an indication of the absence of the previously detected OOB interference. In response, the receiver triggers and enters the recovery phase to restore the front-end gain and/or reactivate the LNA to resume the normal mode operations of the receiver.

To improve stability in a fluctuating noise environment, some embodiments of the adaptive gain control algorithm described herein can incorporate a gain control hysteresis mechanism to add robustness against transient noise fluctuations and prevent mode switching or toggling in response to short-term noise variations. For example, a gain control hysteresis algorithm can be used to bypass the LNA or to reduce the front-end gain according to the hysteresis counter (e.g., the gain control hysteresis algorithm can select between the reduced mode and the bypass mode for the receiver, with the selection performed according to the hysteresis counter maintained by the receiver, etc.). In response to the hysteresis counter subsequently dropping or decreasing, the LNA can be re-enabled and/or the front-end gain can be reset, restoring sensitivity to the receiver by resuming the normal mode operations. Upon each mode transition, the hysteresis counter may be reset (e.g., initialized or re-initialized, set to a value of zero, etc.) to avoid oscillations and to enforce stability in the gain control behavior.

In some aspects, embodiments of the adaptive gain control algorithm can be implemented using a dual-threshold logic, with a first (e.g., high) threshold configured and used for triggering gain reduction by switching the receiver from normal mode to either reduced mode or bypass mode (as well as from reduced mode to bypass mode), and with a second (e.g., low) threshold configured and used for triggering gain restoration to return the receiver to the normal mode operations. The dual-threshold logic of the adaptive gain control algorithm can use the hysteresis gain control and/or hysteresis counter to prevent or reduce the rapid switching between gain states that may otherwise occur in the absence of the hysteresis counter and gain control.

In particular, the hysteresis counter can be maintained by the receiver, with the value of the hysteresis counter reset (e.g., initialized to zero, etc.) by the receiver after each gain restoration is completed, as noted above. From the initialized value, the hysteresis counter is then maintained by the receiver based on the receiver incrementing or decrementing the hysteresis counter based on the current noise conditions measured or otherwise observed by the receiver. For example, the adaptive gain control mechanism can cause the receiver to increment the hysteresis counter when the receiver is operating in the normal mode and elevated noise is detected about the noise floor baseline, and can cause the receiver to decrement the hysteresis counter when the receiver is operating in the reduced gain mode or the LNA bypass mode and the measured noise level detected by the receiver is sufficiently low (e.g., below a corresponding threshold). The gain control hysteresis may be implemented such that a gain state switch is initiated for the receiver only when the hysteresis counter crosses the corresponding threshold. For example, the corresponding threshold may be a threshold value of the hysteresis counter that must be met or exceeded before the receiver will initiate a gain state switch.

In one illustrative example, consider a receiver operating over an 8 megahertz (MHz) bandwidth with a normal mode noise figure (NF) of 5 decibels (dB), resulting in a noise floor of −99.9 decibel-milliwatts (dBm). If the LNA is bypassed and the NF increases to 18 dB, the new noise floor becomes −87 dBm. In such cases, if the observed noise floor rises beyond −87 dBm, the system may choose to bypass the LNA, resulting in a noise floor comparable to that achieved with the LNA enabled. This configuration can assist in preventing potential front-end saturation caused by high-power OOB interference that is not detectable through conventional in-band metrics, while preserving optimal receiver sensitivity. In some examples, the OOB interference detection and mitigation with the dual-threshold logic described above may be configured with a requirement of multiple consecutive observations that satisfy the triggering conditions before any gain change is enacted. By enforcing this observation window with a minimum count of triggering observations before a gain state or gain mode change is implemented for the receiver, the system significantly reduces the likelihood of erroneous switching and maintains stable receiver performance even in dynamically changing environments.

In some aspects, the various noise measurements referred to herein may be noise measurements that are initiated by the receiver device during an idle period, such as a MAC protocol-defined idle period, etc. Initiating and performing the noise measurements during the idle period can ensure that the measurements reflect the actual environmental noise floor, rather than reflecting contributions from transient or ongoing transmissions in the same frequency range and/or wireless medium subject to the monitoring by the receiver. To improve reliability and suppress the effects of transient noise spikes in individual noise measurements, multiple energy readings can be taken (e.g., measured) by the receiver during quiet windows of the idle period, with the multiple energy readings averaged to obtain a more stable and representative average value estimating the background noise level.

In an illustrative example, the noise measurements can be performed by a receiver device during MAC-protocol-defined idle periods. In an IEEE 802.11ah (Wi-Fi HaLow) implementation, the receiver can be a Wi-Fi HaLow receiver, and is configured to periodically sense the medium to assess channel impairments (e.g., periodically sense the medium to obtain noise measurements, etc.) without interrupting ongoing traffic. In some embodiments, noise measurements are conducted during a particular time slot defined by the Wi-Fi HaLow standard in which no other devices are permitted to transmit, ensuring a quiet channel for accurate sensing. For example, in a Wi-Fi HaLow network, these specific time slots occur after the short inter-frame space (SIFS) and during the distributed inter-frame space (DIFS). The IEEE 802.11 WLAN standards employ a collision avoidance mechanism, requiring all devices to remain silent for a duration defined as 2 slots after the SIFS, which defines the duration of the DIFS to be equal to the SIFS duration plus 2 slots. This idle period within the IEEE 802.11 MAC protocol is a periodic and predictable window during which no legitimate transmissions are to occur. In some cases, the SIFS follows the end of a busy time or busy period on the wireless medium, for example corresponding to the end of a packet reception. The SIFS defines a short duration that can be used for higher priority transmissions, such as immediate response frames such as an ACK or block ACK. In such examples, a first portion of the DIFS overlaps (e.g., runs concurrently) with the SIFS, based on the DIFS and SIFS windows beginning measurement from the same point in time following the end of the busy time/period on the medium. The DIFS is longer than the SIFS, based on the DIFS being equal to a duration defined as SIFS duration+2 slot durations, in at least some examples as noted above. Accordingly, a second portion of the DIFS is after the SIFS, and therefore the second portion of the DIFS may follow an ACK indicative of successful reception/transmission of the previous packet.

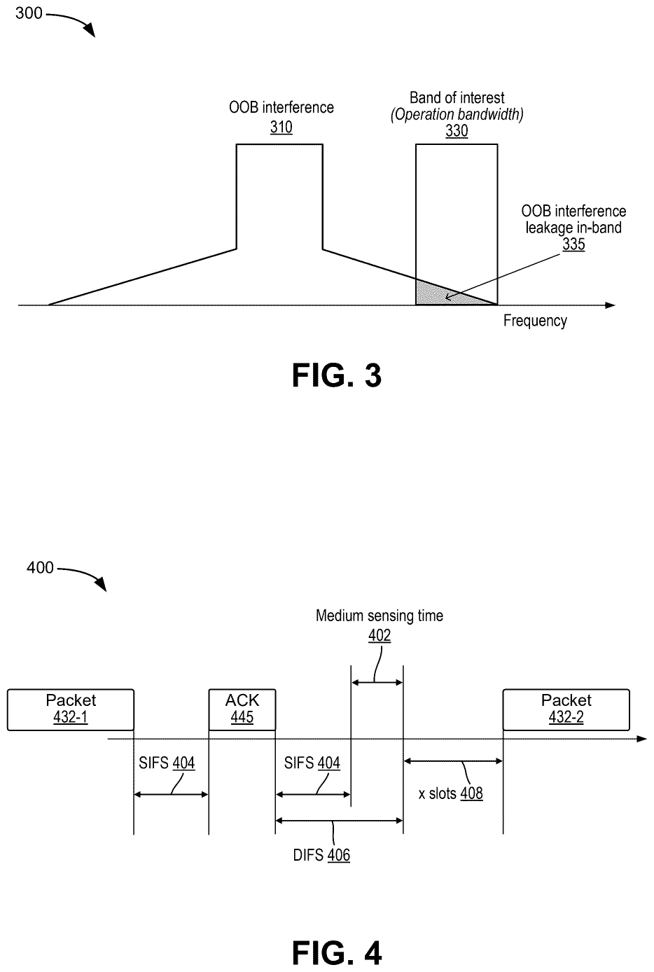

In the specific example of Wi-Fi HaLow, the SIFS duration is 160 microseconds, and the slot time (e.g., slot duration) is 52 microseconds. For example, FIG. 4 is a timing diagram 400 depicting an example of an idle period that can be used for noise measurement(s) between a packet reception and a packet transmission, where the idle period includes a medium sensing time for performing the noise measurement(s), in accordance with some examples. In some embodiments, the medium sensing time for performing the noise measurements is located within a DIFS that follows an ACK (e.g., a valid ACK or block ACK, as noted above) indicating that the previous packet was received or transmitted successfully. For example, in some embodiments the medium sensing time for noise sampling may be located within a DIFS window corresponding to a DIFS following an ACK, not just any packet. In some examples, the DIFS window (e.g., also referred to as the DFS duration) may be measured as a period of time from when the last frame detected on the medium was received correctly (e.g., determined based on a valid ACK or block ACK being received). For instance, when the last frame detected on the medium was received correctly, the idle period during which the medium has to be detected as idle before sending the next frame/packet according to the IEEE 802.11 MAC protocol may be set to the DIFS window/DIFS duration. When the last frame detected on the medium was not received correctly (e.g., valid ACK or block ACK not received), the idle period or quiet time requirement may be provided instead by an Extended Interframe Space (EIFS), corresponding to a unit of time that a STA must defer before transmitting a frame if the previous frame contained an error. Accordingly, the DIFS contemplated herein may be a DIFS following a successful packet reception/correctly receiving the last frame detected on the medium.

In particular, FIG. 4 illustrates an example of an idle period for noise measurement that is between a first packet 432-1 and a subsequent, second packet 432-2. In some examples, the first packet 432-1 may be a packet received by the wireless device, and the second packet 432-2 may be a packet transmitted by the wireless device. In other examples, both of the first packet 432-1 and the second packet 432-2 may be respective packet receptions by the wireless device, etc. In some examples, at least the first packet 432-1 is a packet received by the wireless device (e.g., and the second packet 432-2 may be an additional, subsequent packet reception by the wireless device, or may be a subsequent packet transmission by the wireless device). In an illustrative example, the first packet 432-1 is a valid packet reception, for example as indicated by a corresponding ACK 445 that follows the first packet 432-1 by a time separation given by the SIFS 404. For example, the ACK 445 can be an acknowledgement (e.g., indication) of successful transmission/reception of the first packet 432-1. The wireless medium may be idle for a unit of time of the SIFS 404, for the period following the end of the first packet 432-1 and before the beginning of the ACK 445.

In some embodiments, the ACK 445 indicative of the successful transmission/reception of the earlier, first packet 432-1 is followed by another SIFS 404, which may be included within (i.e., runs concurrently with) the DIFS 406. As noted previously above, the DIFS 406 is longer than the SIFS 404, and for example can be equal to the SIFS 404 plus a certain number of slot durations (e.g., such as DIFS=SIFS+2 slots, etc.). In the example of FIG. 4, the SIFS 404 and DIFS 406 following the ACK 445 may both begin from the same time corresponding to the end of the ACK 445 on the timeline or wireless medium.

Accordingly, the medium sensing time 402 that can be used for noise measurement according to aspects of the present invention may be located within a DIFS (e.g., DIFS 406) that is after an ACK (e.g., ACK 445) indicating the successful/valid reception of the previous packet (e.g., first packet 432-1) on the wireless medium. The medium sensing time 402 within the DIFS 406 can be after an SIFS 404 that is also within the DIFS 406.

In particular, and as illustrated in the example of FIG. 4, the medium sensing time 402 may occur within (i.e., during) the DIFS 406, but after the SIFS 404 that is also within the DIFS 406. In some examples, each device on a wireless medium may be configured to wait for a length of time equal to the DIFS 406 duration plus a random backoff period, prior to the device attempting transmission for their respective packet (e.g., in examples where the second packet 432-2 is a transmitted packet, etc.). For instance, as shown in FIG. 4, the second packet 432-2 occurs after the x slots 408 following the DIFS 406, where x represents a random quantity of slots corresponding to the random backoff period noted above. By configuring a receiver to perform the OOB interference detection measurements of the noise level during the DIFS 406 following the ACK 445, but after the SIFS 404 following the ACK 445 (e.g., performing the OOB interference detection measurements during the medium sensing time 402), aspects of the present disclosure can ensure that noise measurements occur during a quiet interval for obtaining reliable measurements for adaptive gain control.

Additionally, the approach of performing the noise measurements for OOB interference detection can be seen to advantageously avoid measuring during the SIFS 404, as the physical layer of the receiver device may still be settling from the previous reception of the first packet 432-1, during at least a portion of the SIFS 404 that is between the first packet 432-1 and the ACK 445. Attempting noise measurements during the SIFS 404 and while the receiver physical layer is still settling from the previous reception of the first packet 432-1 can lead to transients or other residual effects, and therefore unreliable data of the noise measurements obtained by the receiver. Accordingly, obtaining the noise measurements during the medium sensing time 402 that is within the DIFS 406 that follows the ACK 445, and that is after the SIFS 404 also following the ACK 445 and included within the DIFS 406, can address these challenges and more. In some embodiments, the receiver can be configured to obtain noise measurements at various points (e.g., times, slots, etc.) within the DIFS 406, including immediately after one or two slots have passed from the beginning of the DIFS 406 (e.g. after 52 or 104 microseconds, when the slot length/duration is 52 microseconds), provided that the receiver has a sufficiently fast settling time post-reception. In some embodiments, the noise measurement may even be permitted during the SIFS 404, given implementation-specific constraints are met.

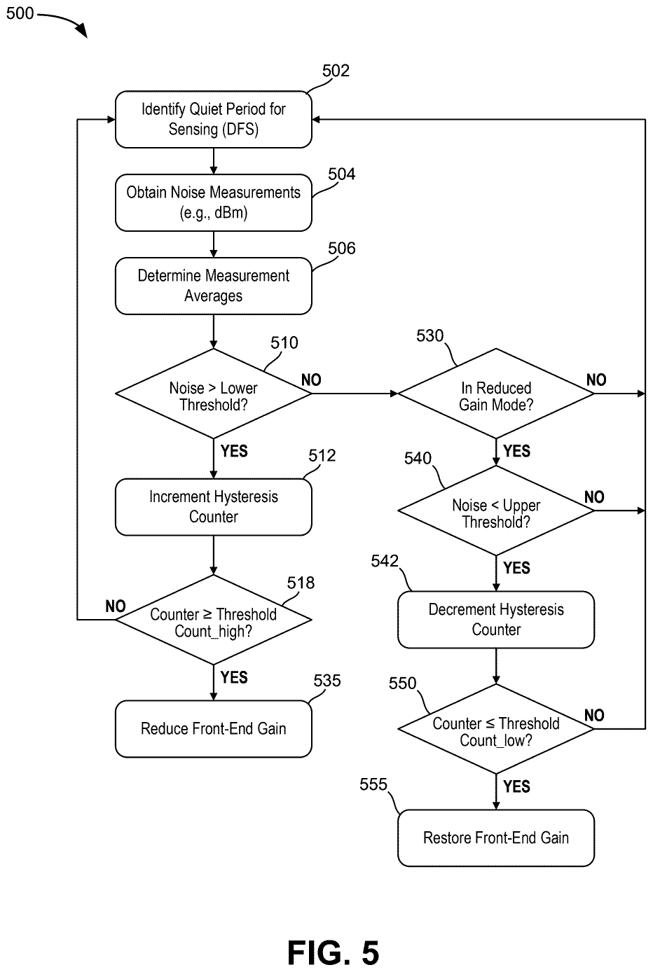

FIG. 5 is a flowchart diagram illustrating an example of a process 500 for adaptive gain control using gain control hysteresis, in accordance with some examples. The process 500 can begin with initializing several parameters used in subsequent steps of the process 500, for example including a hysteresis counter (e.g., corresponding to block 512, where the hysteresis counter is incremented, and further corresponding to block 542, where the hysteresis counter is decremented); an upper threshold for noise level comparisons corresponding to the comparison of block 540; a lower threshold for noise level comparisons corresponding to the comparison of block 510; a hysteresis counter high threshold corresponding to the comparison of block 530; and a hysteresis counter low threshold corresponding to the comparison of block 550.

At block 502, the process 500 for adaptive gain control can begin by identifying an idle period for sensing, for example, sensing during the distributed inter-frame space (DIFS) (e.g., such as DIFS 406 of FIG. 4, etc.) and/or sensing during a medium sensing time within the DIFS and after the SIFS (e.g., such as the medium sensing time 402 of FIG. 4, etc.).

At block 504, the process 500 includes measuring a noise level in dBm within the idle period identified at block 502. The terms “idle period” and “quiet period” may be used interchangeably herein, and may correspond to the DIFS 406 of FIG. 4 and/or the medium sensing time 402 that is within the DIFS 406 and after the SIFS 404 of FIG. 4, etc.). To avoid false triggers due to transient fluctuations in the noise measurements and noise level thereof, the receiver can be configured to perform multiple noise measurement at block 504.

At block 506, the process includes determining an average noise value from the multiple noise measurements obtained at block 504.

At block 510, the process 500 for implementing the disclosed adaptive gain control algorithm is configured to compare the noise measurement average(s) determined in block 506 to a lower noise threshold. Based on a determination that the noise measurement average exceeds the lower noise threshold, the process 500 proceeds via the ‘YES’ decision pathway from block 510 to block 512.

At block 512, the process 500 includes incrementing the hysteresis counter in response to the average noise value exceeding the lower noise threshold.

Following block 512, the process 500 proceeds to block 518, and compares the updated hysteresis counter to a high hysteresis threshold. If the updated hysteresis counter reaches or exceeds the high hysteresis threshold (e.g., counter≥threshold count_high), process 500 proceeds via the ‘YES’ decision pathway from block 518 to block 535, which causes the receiver to respond by reducing the front-end gain to thereby cause the receiver to operate in a reduced gain mode. In another embodiment, the ‘YES’ decision pathway from block 518 to block 535 can cause the receiver to bypass the LNA entirely when the updated hysteresis counter reaches or exceeds the high threshold, which can be referred to as the reduced gain mode, or a bypass mode.

If the updated hysteresis counter does not reach or exceed the high hysteresis threshold (e.g., counter<threshold count_high), process 500 proceeds via the ‘NO’ decision pathway from block 518 to return to block 502 at the start of process 500. For example, in cases where the updated hysteresis counter is below the high threshold for the hysteresis counter, the receiver continues to identify subsequent idle periods (e.g. at block 502) and take noise measurements (e.g., at block 504) to update the average noise value accordingly (e.g., at block 506), etc.

In scenarios where, at block 510, the receiver determines that the noise measurement average (e.g., of block 506) does not exceed the lower noise threshold, the process 500 proceeds via the ‘NO’ decision pathway from block 510 to block 530, and checks the current gain mode of the receiver. In some embodiments, block 530 corresponds to checking if the receiver is operating in a reduced gain mode.

In scenarios where the receiver is operating in a reduced gain mode (e.g., ‘YES’ determination at block 530), and the average noise value is not greater than the lower noise threshold (e.g., ‘NO’ determination at block 510), the process 500 proceeds to compare the average noise value against the upper noise threshold at block 540. If the average noise value is below the upper noise threshold, the process 500 proceeds via the ‘YES’ decision pathway from block 540 to block 542, and decrements the hysteresis counter at block 542. If the average noise value is not below the upper noise threshold, the process 500 proceeds via the ‘NO’ decision pathway from block 540 return to the start of process 500 at block 502, as described previously above with respect to the ‘NO’ decision pathway from block 518.

From block 542, the process 500 proceeds to block 550 and evaluates whether the updated hysteresis counter has fallen to be equal to or below the low hysteresis counter threshold. Based on determining the updated hysteresis counter ≤the low hysteresis counter threshold, the process 500 proceeds via the ‘YES’ decision pathway from block 550 to block 555, and restores the front-end gain of the receiver, thereby returning the receiver to operating in the normal gain mode.

The receiver continues to identify idle periods (e.g., at block 502) and measure noise levels (e.g., at block 504) to update the average noise value (e.g., at block 506) accordingly when the receiver is in normal mode, as well as when the receiver is in reduced gain mode (e.g., ‘YES’ decision pathway from block 530) but the average noise value is still higher than the upper noise threshold (e.g., ‘NO’ pathway from block 540), or after the hysteresis counter is decremented (e.g., at block 542) but the updated hysteresis counter remains above the low threshold (e.g., ‘NO’ decision pathway from block 550). For example, based on determining the updated hysteresis counter >the low hysteresis counter threshold at block 550, the process 500 proceeds via the ‘NO’ decision pathway from block 550 to return to block 502 and the start of process 500, as described previously above.

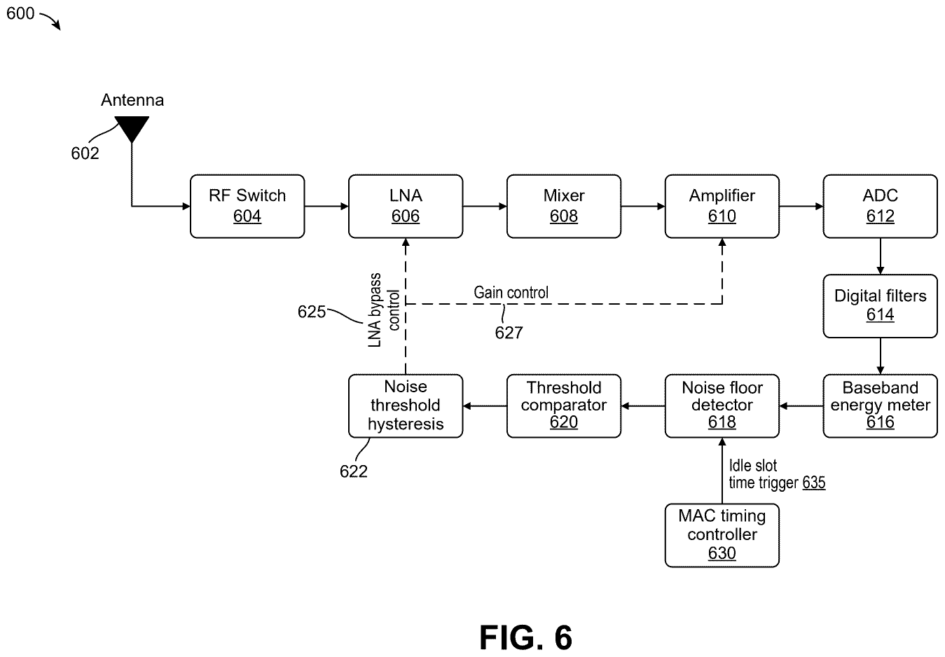

FIG. 6 is a diagram illustrating an example architecture for an adaptive gain control system 600 that can be used to implement aspects of the present invention, in accordance with some examples. The adaptive gain control system 600 can include and/or implement an RF signal chain beginning from an antenna 602, which receives incoming signals and passes the received signals through an RF switch 604 configured and used for signal routing. The signal is directed from the RF switch 604 to a bypassable LNA 606 (e.g., an LNA that can be bypassed or not bypassed), which can be configured to amplify relatively weak signals under normal conditions such as during the normal mode operation of the adaptive gain control system 600. The bypassable LNA 606 can be bypassed (e.g., skipped, not used, etc.) by the RF switch 604 and/or the adaptive gain control system 600 in order to prevent saturation under strong OOB interference, as has been noted previously above.

From the bypassable LNA 606, the adaptive gain control system 600 includes a mixer 608 that can be used to downconvert the input RF signal to baseband. The resulting baseband signal output from the mixer 608 is then amplified by an amplifier 610, and passed to an analog-to-digital converter (ADC) 612, which digitizes the amplified signal for further processing by downstream components of the adaptive gain control system 600 and RF signal chain thereof shown in FIG. 6. For example, the digitized signal output from the ADC 612 can be processed and refined by a set of digital filters 614, and provided to a baseband energy meter 616 configured to generate a digital power estimate and/or other noise metric for noise floor analysis by the noise floor detector 618.

In parallel, a MAC timing controller 630 can be configured and used to identify idle transmission periods, such as the DIFS (e.g., DIFS 406 of FIG. 4, etc.). The identification of idle transmission periods by the MAC timing controller 630 can correspond to the operations of block 502 of the process 500 of FIG. 5, in some embodiments. The identification of idle transmission periods by the MAC timing controller 630 can correspond to the MAC timing controller 630 generating one or more idle slot time triggers 635, which trigger the noise floor detector 618 to perform noise measurements exclusively during the quiet intervals identified by the MAC timing controller 630.

The output of the noise floor detector 618 is provided to a threshold comparator 620, which is configured to determine whether the measured noise level (e.g., determined by the noise floor detector 618, and included in the input provided to the threshold comparator 620 from the noise floor detector 618) exceeds one or more configured limits or pre-defined thresholds. The output of the threshold comparator 620 is indicative of the comparison result, and can be provided to the noise threshold hysteresis logic 622, which implements a dual-threshold counter scheme (e.g., as described previously above with respect to FIGS. 3-5, etc.) to provide stability in gain control decisions implemented by the adaptive gain control system 600.

Based on the comparison result of the noise threshold hysteresis logic 622 to the corresponding hysteresis high and/or low threshold values, the adaptive gain control system 600 may determine to reduce the front-end gain of the receiver and/or bypass the LNA 606 in response to the noise threshold hysteresis counter reaching a first threshold value. The adaptive gain control system 600 may determine to restore the front-end gain of the receiver and/or enable the LNA 606 in response to the noise threshold hysteresis counter reaching a second threshold value, different from the first threshold value.

In some embodiments, reducing and/or restoring the front-end gain of the receiver corresponds to reducing and/or restoring the gain of the amplifier 610, and can be implemented based on one or more gain control signals 627 which may be generated and issued by the noise threshold hysteresis logic 622 to the amplifier 610. In some embodiments, bypassing and/or enabling the LNA 606 can be controlled according to one or more LNA bypass control signals 625 that can be signaled from the noise threshold hysteresis logic 622 to the LNA 606. In some examples, when OOB interference is detected, determined, and/or suspected, the LNA bypass control signal 625 is issued from the noise threshold hysteresis logic 622 to dynamically switch the LNA 606 on or off, thereby protecting the receiver front-end from saturation conditions. Advantageously, the adaptive gain control system 600 can be used to provide closed-loop control for real-time adaptive behavior in controlling the receiver front-end gain in response to elevated noise detection outside of the operating bandwidth for the receiver (e.g., in response to OOB noise or interference detection, etc.), while further being seen to minimize the unnecessary gain transitions or toggling of the receiver gain state that may otherwise be caused by transient fluctuations in the measured noise level.

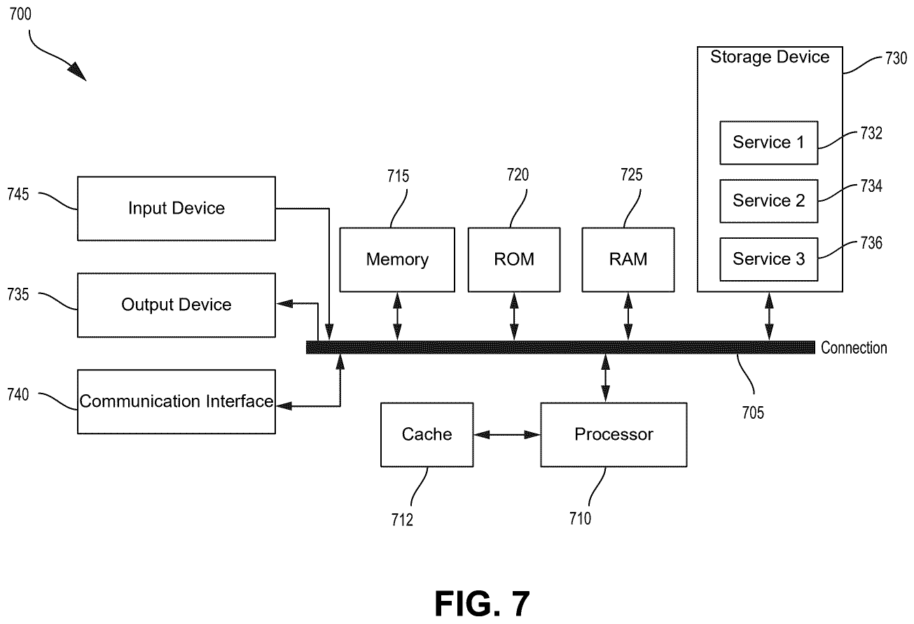

FIG. 7 illustrates a computing device architecture 700 of a computing device which can implement one or more techniques described herein. In some examples, the computing device can include a mobile device, a wearable device, an extended reality device (e.g., a Virtual Reality (VR) device, an Augmented Reality (AR) device, or a Mixed Reality (MR) device), a personal computer, a laptop computer, a video server, a vehicle (or computing device of a vehicle), or other device. The components of computing device architecture 700 are shown in electrical communication with each other using connection 705, such as a bus. The computing device architecture 700 includes a processing unit 710 and computing device connection 705 that couples various computing device components including computing device memory 715, such as Read Only Memory (ROM) 720 and Random-Access Memory (RAM) 725, to processor 710.

Computing device architecture 700 can include a cache of high-speed memory connected directly with, in close proximity to, or integrated as part of processor 710. Computing device architecture 700 can copy data from memory 715 and/or the storage device 730 to cache 712 for quick access by processor 710. In this way, the cache can provide a performance boost that avoids processor 710 delays while waiting for data. These and other engines can control or be configured to control processor 710 to perform various actions. Other computing device memory 715 may be available for use as well. Memory 715 can include multiple different types of memory with different performance characteristics. Processor 710 can include any general-purpose processor and a hardware or software service, such as service 1 732, service 2 734, and service 3 736 stored in storage device 730, configured to control processor 710 as well as a special-purpose processor where software instructions are incorporated into the processor design. Processor 710 may be a self-contained system, containing multiple cores or processors, a bus, memory controller, cache, etc. A multi-core processor may be symmetric or asymmetric.

To enable user interaction with the computing device architecture 700, input device 745 can represent any number of input mechanisms, such as a microphone for speech, a touch-sensitive screen for gesture or graphical input, keyboard, mouse, motion input, speech and so forth. Output device 735 can also be one or more of a number of output mechanisms known to those of skill in the art, such as a display, projector, television, speaker device, etc. In some instances, multimodal computing devices can enable a user to provide multiple types of input to communicate with computing device architecture 700. Communication interface 740 can generally govern and manage the user input and computing device output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, RAM, ROM, and hybrids thereof. Storage device 730 can include services 732, 734, 736 for controlling processor 710. Other hardware or software modules or engines are contemplated. Storage device 730 can be connected to the computing device connection 705. In one aspect, a hardware module that performs a particular function can include the software or processor readable codes stored in a computer-readable medium in connection with the necessary hardware components, such as processor 710, connection 705, output device 735, and so forth, to carry out the function.

The term “device” is not limited to one or a specific number of physical objects (such as one smartphone, one controller, one processing system and so on). As used herein, a device may be any electronic device with one or more parts that may implement at least some portions of this disclosure.

Individual aspects may be described above as a process or method which is depicted as a flowchart or a data flow diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, or a subprogram. When a process corresponds to a function, its termination can correspond to a return of the function to the calling function or the main function.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above.

The program code may be executed by a processor, which may include one or more processors, such as one or more Digital Signal Processors (DSPs), general purpose microprocessors, an Application Specific Integrated Circuits (ASICs), Field Programmable Gate Arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices.

What is claimed is:

1. A method for gain control in a wireless device, the method comprising:
obtaining one or more noise measurements during an idle period for a wireless medium associated with the wireless device, wherein the one or more noise measurements are indicative of a noise level within an operating bandwidth of the wireless device during the idle period;
determining, based on the noise level, a noise floor metric indicative of elevation in a noise floor corresponding to the operating bandwidth;
determining a presence of out-of-band (OOB) interference located outside of the operating bandwidth based on comparing the noise floor metric to at least one threshold to determine a comparison result, wherein the elevation in the noise floor is used as an indicator for the presence of the OOB interference; and
controlling a front-end gain of a receiver of the wireless device according to at least one of the comparison result or the noise floor metric.

2. The method of claim 1, wherein controlling the front-end gain of the receiver comprises:
reducing a gain of an amplifier in a receive chain; or
bypassing one or more components in the receive chain, wherein the one or more components include the amplifier.

3. The method of claim 2, wherein:
the amplifier comprises a low-noise amplifier (LNA) associated with a first gain for a normal mode configuration of the receiver; and
reducing the gain comprises configuring the amplifier with a reduced gain less than the first gain, wherein the reduced gain corresponds to a reduced mode configuration of the receiver.

4. The method of claim 3, wherein the wireless device includes an adaptive gain control component configured to generate one or more control signals to cause the wireless device to switch between the normal mode configuration and the reduced mode configuration.

5. The method of claim 1, wherein:
the one or more noise measurements comprise a plurality of noise measurements; and
determining the noise floor metric includes calculating an average noise level of the plurality of noise measurements.

6. The method of claim 5, further comprising comparing the average noise level with a configured threshold noise level to determine the comparison result, and wherein the indicator for the presence of the OOB interference comprises determining that the average noise level exceeds the configured threshold noise level.

7. The method of claim 1, further comprising identifying the idle period for the wireless medium as a quiet period associated with a medium access control (MAC) protocol implemented for the wireless medium and the receiver.

8. The method of claim 1, wherein the idle period is within a distributed inter-frame space (DIFS) and is after a short inter-frame space (SIFS).

9. The method of claim 1, wherein obtaining the one or more noise measurements during the idle period is performed after receiving or transmitting an acknowledgement (ACK).

10. The method of claim 1, wherein determining the noise floor metric comprises comparing the noise level against an expected threshold indicative of the presence of OOB interference, wherein the noise floor metric is an indicator for the presence of OOB interference based on a determination the noise level exceeds the expected threshold.

11. The method of claim 10, further comprising determining whether the OOB interference has cleared by comparing one or more additional noise measurements to an additional threshold, wherein the one or more additional noise measurements are obtained after an initial determination the OOB interference is present.

12. The method of claim 11, further comprising restoring the front-end gain of an amplifier of the receiver in response to a determination the OOB interference has cleared, wherein the determination the OOB interference has cleared is based on the one or more additional noise measurements indicating an updated noise floor metric below the additional threshold.

13. The method of claim 1, further comprising:
incrementing a hysteresis counter upon detection of an elevated noise floor based on the noise level;
comparing the hysteresis counter to a high threshold; and
controlling the front-end gain to initiate a gain reduction in response to the hysteresis counter being greater than or equal to the high threshold, wherein the gain reduction causes the receiver to operate in a reduced gain mode.

14. The method of claim 13, wherein incrementing the hysteresis counter comprises:
computing an average noise level of multiple noise measurements;
comparing the average noise level to a lower noise threshold; and
incrementing the hysteresis counter in response to a determination the average noise level exceeds the lower noise threshold.

15. The method of claim 13, further comprising:
decrementing the hysteresis counter upon detection of a low noise floor while the receiver operates in the reduced gain mode;
comparing the hysteresis counter to a low threshold; and
restoring the front-end gain of the receiver in response to the hysteresis counter reaching the low threshold.

16. The method of claim 15, wherein the detection of the low noise floor comprises determining an average noise level of the one or more noise measurements is less than an upper noise threshold.

17. The method of claim 15, wherein restoring the front-end gain of the receiver comprises resetting the gain of an amplifier included in the receiver or re-activating an amplifier bypassed in a bypass mode of the receiver.

18. The method of claim 1, wherein determining the noise floor metric includes calculating a statistical representation of the one or more noise measurements or a measured noise level over time.

19. The method of claim 18, wherein calculating the statistical representation includes one or more of averaging a plurality of noise levels, performing statistical analysis of the plurality of noise levels, or performing historical data aggregation of noise levels across different operating conditions or time periods.

20. A wireless device operating in a wireless network, comprising:
a receiver configured for reception of one or more signals on a wireless medium, the receiver including a receive chain with at least one low-noise amplifier (LNA);
a processor, communicatively coupled to the receiver; and
one or more memory banks, communicatively coupled to the processor and storing processor-readable instructions that, when executed by the processor, cause the processor to:
obtain one or more noise measurements during an idle period for the wireless medium, wherein the one or more noise measurements are indicative of a noise level within an operating bandwidth of the wireless device during the idle period;
determine, based on the noise level, a noise floor metric indicative of elevation in a noise floor corresponding to the operating bandwidth;
determine a presence of out-of-band (OOB) interference located outside of the operating bandwidth based on comparing the noise floor metric to at least one threshold to determine a comparison result, wherein the elevation in the noise floor is used as an indicator for the presence of the OOB interference; and
control a front-end gain of the receiver by adjusting a gain of the LNA according to at least one of the comparison result or the noise floor metric.
